(19) United States
(12) Patent Application Publication
(10) Pub. No.: US 2003/0207125 A1
(43) Pub. Date: Nov. 6, 2003

(54) Base substrate for crystal growth and manufacturing method of substrate by using the same

(75) Inventors: Haruo Sunakawa, Tokyo (JP); Yoshishige Matsumoto, Tokyo (JP); Akira Usui, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/443,794

(22) Filed: May 23, 2003

Related U.S. Application Data
(62) Division of application No. 09/691,113, filed on Oct. 19, 2000.

(30) Foreign Application Priority Data
Oct. 22, 1999 (JP) 11-301158

(51) Int. Cl. B32B 9/00

(52) U.S. Cl. 428/428; 438/764

(57) ABSTRACT

After a GaN film 12 is formed on a (0001) plane sapphire (Al₂O₃) substrate 11, islands of the GaN film 12 are formed by wet etching. An upper part of the islands of the GaN film 12 is a single-crystal layer. By performing epitaxial growth over the islands of GaN film 12, a GaN film 15 with little crystal defect is obtained.

### BACKGROUND OF THE INVENTION

1. Field of the Invention

The present invention relates to a technique of forming, on a base substrate, an epitaxial layer of a crystal system different from that of the base substrate.

2. Description of the Related Art

There is an epitaxy technique as one of crystal growth techniques. The epitaxy is a technique for succeeding crystal properties of a substrate and growing a layer crystal mainly so as to cover the surface of a base crystal. A main thing expected in the epitaxy is to form a crystal layer having desired properties on the substrate.

There is an example in which GaAs is subjected to the epitaxy on a GaAs substrate prepared by a LEC (liquid encapsulated czochralski) or the like and then sliced, and a GaAs epitaxial layer having a desired thickness, kind of impurity and density can be formed by the epitaxy. It is well known that, as semiconductor devices in which the epitaxy technique plays a decisive role, there are a semiconductor laser, a two-dimensional electron gas transistor generally called HEMT, and the like. In these devices, a crystal layer of the same type as that of the base crystal or a crystal layer of a different type from that of the base crystal is subjected to the epitaxy on the base crystal, whereby a so-called hetero-structure is formed. A common respect in the aforementioned examples is that the crystal layer having almost the same crystal structure and lattice constant as those of the base crystal is formed on the base crystal by the epitaxy, and therefore, the epitaxy is an essential technique in manufacturing the semiconductor device as described above.

Even according to such an epitaxy technique, however, there are many cases where the base substrate matched with the crystal for the aforementioned epitaxy in points of the crystal structure, a lattice constant and the like cannot be prepared. Here, the matching of the lattice constant usually means that there is scarcely a difference between the lattice constants of the base substrate and the epitaxial layer, and this fact roughly means that these lattice constants are very close to each other to such an extent that the occurrence of crystal defects such as dislocation based on a mismatch of the lattice constants is scarcely observed in the epitaxial layer. The lattice constant is also a function of temperature, and even when the difference between the lattice constants is small, strain increases, so that the defects occur, if the epitaxial layer is thickened. Needless to say, it is impossible to sweepingly decide the matching conditions of the lattice by considering the difference alone between the lattice constants. Moreover, the lattice match in a broad sense also includes a case where the following relation is satisfied:

ma₁≈na₂ (m, n: natural numbers)

wherein a₁ is a lattice constant of a base crystal substrate, and a₂ is a lattice constant of a crystal layer formed on the substrate.

As a material having a problem due to the absence of such an appropriate base crystal, most noticeable is a group III-nitride material. There has not been found yet any base substrate which is matched with the crystal of the group III-nitride material typified by GaN in points of the crystal structure, lattice constant and the like. Sapphire, SiC, MgAl₂O₄ and the like are broadly utilized as the base substrate. When the base substrate consisting of a material of a different type from that of the material constituting the epitaxial layer is used in this manner, usually a method is employed which comprises forming a buffer layer on the base substrate, and then forming a predetermined epitaxial layer on the buffer layer. In the epitaxial layer formed in this manner, however, a large number of crystal defects such as dislocation are generated. Reduction of these crystal defects is a remarkably important technical theme in applying the aforementioned epitaxial layer to devices such as a semiconductor laser.

As a method for obtaining the group III-nitride material having the relatively small crystal defects, known is a method of forming a low-temperature buffer layer on a heterogeneous substrate such as sapphire or the like, and then forming an epitaxial growth layer on the buffer layer. As an example of a crystal growth method using the low-temperature deposition buffer layer, “Applied Physics, Vol. 68, No. 7 (1999) pp. 768-773” (hereinafter referred to as document 1) discloses the following process. First, by depositing AlN or GaN on a sapphire substrate at about 500° C., an amorphous film or a continuous film partially including a polycrystal is formed. A part of this film is evaporated by raising the temperature to about 1000° C., or crystallized to form a crystal nucleus having a high density. This is used as a growth nucleus to form a GaN film having a relatively good crystal. FIG. 4 of the aforementioned document 1 shows this state, and shows that after high-temperature treatment, an aggregate such as a hexagonal pyramid group is formed.

However, even when the aforementioned method of forming the low-temperature deposition buffer layer is used, as described in the aforementioned document, the crystal defects such as through dislocation and void pipe are present on the order of 10⁸ to 10¹¹ cm⁻², so that problems such as the abnormal diffusion of electrodes and the increase of a non-radiation recombination level are caused sometimes.

Under such circumstances, in recent years, a new crystal growth technique called a pendeo epitaxy (hereinafter abbreviated to “PE” as occasion demands) has been noticed. An outline of the PE technique will be described hereinafter. FIG. 11 is a schematic diagram of an epitaxial growth cross section to show the concepts of two modes of PE, and the similar drawing is also introduced in a document (Tsvetankas. Zhelevaet. Al.; MRS Internet J. Nitride Semicond. Res. 4S1, G3.38 (1999); hereinafter referred to as document 2). In both FIGS. 11(a) and (b), an AlN film 102 is formed on a 6H—SiC base crystal 101, and a GaN 103 is then formed. Afterward, a selective etching mask is formed by a lithography technique, and subsequently the GaN 103, AlN 102, and further 6H—SiC base crystal 101 are selectively etched, whereby a pattern extended in a stripe shape in a vertical direction to a paper surface is formed as shown in the drawings. Thereafter, a GaN seed crystal layer shown as a PE layer 104 in the drawing is formed. In the drawing, a deposited layer 105 will be ignored for a while in performing the description.

FIG. 11(a) is different from FIG. 11(b) in a growth starting point of the PE layer 104. In FIG. 11(a), (11-20) crystal face as a side wall surface of the GaN 103 is used as a starting point and the growth of the PE layer 104 proceeds. On the other hand, in FIG. 11(b), a (0001) crystal face as the top surface of the GaN 103 is used as the starting point and the growth of the PE layer 104 proceeds. Such a difference between the growth starting points is brought about by a difference in formation conditions of the PE layer 104. However, in either case, a remarkably fast crystal growth speed is observed in the (11-20) crystal face of the GaN 103.

FIG. 12 shows an epitaxial growth cross section of a continuous film grown in periodically arranged stripe patterns, and FIGS. 12(a) and (b) are schematic diagrams corresponding to FIGS. 11(a) and (b), respectively. With respect to the two schematic diagrams shown in FIG. 12, the above-mentioned document 2 shows excellent sectional photographs, but in the present specification, the schematic drawings are shown. The PE layer 104 is a continuous layer. It is remarkably interesting by itself that when the epitaxial growth is carried out on the stripe periodic pattern, the continuous-film PE layer is formed, but it is more important that there are few defects such as the dislocation of the continuous-film PE layer. This is because the dislocation in the crystal of GaN or the like having a wurtzite structure extends in a substantially vertical direction with respect to a (0001) plane, and a large amount of dislocation in the striped GaN 103 fails to be succeeded in PE in which a fast growth in a (11-20) direction is dominant. That is, a dislocation density decreases in the PE layer 104 formed by PE, so that if the PE layer is used as the substrate, it is expected to enhance the performance of a light emitting diode (LED) or a semiconductor laser (LD) of GaN or the like. Additionally, the deposited layer 105 shown in FIG. 11 indicates that the slight deposition of GaN occurs during PE growth also in a region other than a stripe region, and the deposited layer 105 is omitted in FIG. 12. A crystal property of the deposited layer 105 itself is generally poor, but the formation of the deposited layer 105 has no influence on the crystal property of the PE layer 104.

As described above, the use of the pendeo epitaxy permits reducing the crystal defect of the epitaxial layer. However, since the pendeo epitaxy requires intricate processes, there is room for various improvements.

In the pendeo epitaxy, it is necessary to form a pattern prior to the growth of the crystal. In the pattern formation described in the above-mentioned document 2, as described in Applied Physics Letter (Appl. Phys. Lett.) Vol. 71, No. 25, pp. 3631-3633 (hereinafter abbreviated to document 3), a nickel film is subjected to the pattern formation with a photoresist, and used as a mask to perform selective etching, whereby the striped GaN of a periodic pattern is formed. As described above, intricate processes such as the deposition of a mask material for the selective etching, lithography, selective etching, and the removal of the mask material are necessary in the PE growth. Not only the intricate processes but also preparation of an expensive exposure apparatus for the lithography are necessary, and tools such as a glass mask for the exposure are also necessary. Furthermore, since the intricate processes have to be performed, the substrate surface is easily contaminated in a stage before the epitaxial growth, and the quality of the epitaxial layer is deteriorated on occasion. Particularly in the pendeo epitaxy, a process of removing the photoresist is essential, but when this removal is not sufficient and a photoresist residue occurs, an adverse influence is exerted on the subsequent epitaxial layer growth, so that the smooth PE growth is not accomplished on the entire surface of a wafer during the growth on occasion.

### SUMMARY OF THE INVENTION

In consideration of the aforementioned circumstances, an object of the present invention is to remarkably reduce a crystal defect of an epitaxial crystal layer formed on a substrate of a heterogeneous material without complicating processes. According to the present invention, there is provided a base substrate for crystal growth for use as a base for growing an epitaxial crystal layer, said base substrate for crystal growth comprising a base substrate of a crystal system different from that of the epitaxial crystal layer, and a plurality of insular crystals formed apart from one another on the base substrate, said insular crystal including a single-crystal layer of the same crystal system as that of the epitaxial crystal layer.

Here, it is preferable that a lattice constant of the insular crystal be substantially equal to a lattice constant of the epitaxial crystal layer. Here, “substantially equal” means that a difference between both the lattice constants is about 5% or less. Moreover, it is preferable that each crystal axis direction of the single-crystal layer substantially agrees with each crystal axis direction of the epitaxial crystal layer.

The insular crystal is preferably constituted of (i) a lower polycrystalline layer formed on the base substrate, and an upper single-crystal layer of the same crystal system as that of the epitaxial crystal layer formed on the lower polycrystalline layer, or mainly constituted of (ii) a single crystal of the same crystal system as that of the epitaxial crystal layer.

Moreover, the base substrate can be constituted to have a concave/convex shape, and the insular crystal may be formed on a convex portion of the concave/convex shape.

Furthermore, according to the present invention, there is provided a substrate wherein the epitaxial crystal layer is formed on the insular crystal of the aforementioned base substrate for crystal growth.

Moreover, according to the present invention, there is provided a method of manufacturing a base substrate for crystal growth which comprises a base substrate and a plurality of insular crystals formed apart from one another on the base substrate and which is used as a base for growing an epitaxial crystal layer of a crystal system different from that of the base substrate, said method comprising:

a step of forming a buffer layer of the same crystal system as that of the epitaxial crystal layer on the surface of the base substrate directly or via another layer; and

a step of subjecting a part of the buffer layer to wet etching to leave an insular region, and forming the insular crystal including a single-crystal layer of the same crystal system as that of the epitaxial crystal layer.

Moreover, according to the present invention, there is provided a method of manufacturing a base substrate for crystal growth which comprises a base substrate and a plurality of insular crystals formed apart from one another on the base substrate and which is used as a base for growing an epitaxial crystal layer of a crystal system different from that of the base substrate, said method comprising:

a step of forming a first buffer layer at a first growth temperature on the surface of the base substrate directly or via another layer;

a step of forming a second buffer layer of the same crystal system as that of the epitaxial crystal layer at a second growth temperature higher than the first growth temperature; and

a step of subjecting a part of the first and second buffer layers to wet etching to leave an insular region, and forming the insular crystal including a single-crystal layer of the same crystal system as that of the epitaxial crystal layer.

Here, the first buffer layer can be a layer of the same crystal system as that of the epitaxial crystal layer.

In these manufacturing methods, during the wet etching of the buffer layer, at least a part of the exposed surface of the base substrate may be etched.

Moreover, according to the present invention, there is provided a method of manufacturing a base substrate for crystal growth which comprises a base substrate and a plurality of insular crystals formed apart from one another on the base substrate and which is used as a base for growing an epitaxial crystal layer of a crystal system different from that of the base substrate, said method comprising a step of insularly depositing a crystal layer including a single-crystal layer of the same crystal system as that of the epitaxial crystal layer on the surface of the base substrate directly or via another layer to form the insular crystal.

In this manufacturing method, after the insular crystal is formed, at least a part of the exposed surface of the base substrate may be etched.

In the aforementioned respective manufacturing methods, preferable is (i) a constitution comprising a lower polycrystalline layer formed on the base substrate, and an upper single-crystal layer of the same crystal system as that of the epitaxial crystal layer formed on the above lower polycrystalline layer and formed, or (ii) a constitution mainly comprising a single crystal of the same crystal system as that of the epitaxial crystal layer.

In the base substrate for crystal growth and the manufacturing method of the present invention, a covering ratio of the insular crystal with respect to the surface of the base substrate can be, for example, in a range of 0.1% to 60%. Moreover, an average particle size of the insular crystals can be in a range of 0.1 μm to 10 μm. Furthermore, an average interval between the adjacent insular crystals can be in a range of 10 μm to 500 μm. Additionally, a number density of the insular crystals can be in a range of 10⁻⁵ crystals/μm² to 10⁻² crystals/μm².

In the present invention, the epitaxial crystal layer can be formed, for example, of a nitride-based material of an element in the group III.

Moreover, according to the present invention, there is provided a base substrate for crystal growth manufactured by the aforementioned method of manufacturing the base substrate for crystal growth.

Furthermore, according to the present invention, there is provided a method of manufacturing a substrate, comprising a step of using the aforementioned method of manufacturing the base substrate for crystal growth to manufacture the base substrate for crystal growth; and a step of subsequently forming an epitaxial growth layer of the same crystal system as that of the insular crystal so as to embed the insular crystal. In the manufacturing method, the epitaxial growth layer is formed by growth using the insular crystal as a growth starting point. Moreover, according to the present invention, there is provided a substrate manufactured by the method of manufacturing the substrate.

Actions of the aforementioned present invention will be described hereinafter.

The crystal structure of the epitaxial growth layer formed on a wafer for the crystal growth of the present invention is different from that of a heterogeneous substrate and the same as that of the insular crystal. Therefore, the epitaxial growth layer preferentially grows from the insular crystal having the same crystal structure, and the growth from the heterogeneous substrate as the starting point is relatively inhibited. Therefore, the crystal defect included in the heterogeneous substrate, or generated in an interface of the heterogeneous substrate and the epitaxial layer can be prevented from being transmitted to the epitaxial growth layer, and the crystal defect in the epitaxial growth layer can effectively be reduced.

As described above, in the present invention, the crystal defect is inhibited from being introduced from the heterogeneous substrate by the constitution provided with the insular crystal. However, only with this constitution, it is difficult to realize the crystal structure of a presently demanded high quality level. In order to depress the crystal defect, and realize the crystal structure of the high quality level, it is important to also reduce the crystal defect included in the insular crystal itself as the starting point of the crystal growth. Therefore, in the present invention, the insular crystal is constituted to include the single-crystal layer, and remarkable reduction of the crystal defect in the epitaxial layer is realized. A reason why the crystal defect is remarkably reduced by employment of the aforementioned constitution is not necessarily clear, but it is assumed that since the epitaxial layer growth using the single-crystal layer with substantially no crystal defect as the growth starting point preferentially proceeds, substantially no crystal defect is transmitted from a point other than the growth starting point.

As described above, since the insular crystal including the single-crystal layer is the growth starting point of the epitaxial layer in the present invention, the crystal defect in the epitaxial growth layer can remarkably be reduced.

Moreover, since the insular crystal can be formed in a relatively simple manufacture process, according to the present invention, there are obtained advantages that yield is enhanced, and that wafer contamination during manufacture can effectively be prevented. As described above, in the crystal growth by the pendeo epitaxy, since the striped pattern needs to be formed, a lithography process including dry etching needs to be performed. On the other hand, in the present invention, as a method of forming the insular crystal, it is possible to employ: (i) a method of forming a film for forming the insular crystal, and subsequently forming an island shape by wet etching; (ii) a method of forming the insular crystal including the single crystal during the crystal growth by adjusting a film forming material, film forming temperature, and the like; and other various simple methods. Therefore, it is unnecessary to perform a complicated process such as the pendeo epitaxy, and disadvantages such as introduction of impurities into the crystal for process reasons can therefore be avoided.

Furthermore, according to the present invention, substrate bending can be reduced. A large bending is usually seen in the wafer removed from a growth apparatus after the epitaxial growth, but the bending is substantially eliminated after the epitaxial layer is separated from the base substrate. This is supposedly because the epitaxial layer is connected to the base substrate only by the insular crystal, and a cause for the bending before the separation is substantially determined only by a difference of a thermal expansion coefficient between the base substrate and the epitaxial layer by a temperature change from a growth temperature to a room temperature. Particularly, the bending is remarkably eliminated when the covering ratio of the insular crystal is 10% or less.

As described above, the present invention is characterized in that the insular crystal including the single-crystal layer is formed, and the epitaxial layer is grown from the insular crystal as the growth starting point, but in order to further clarify such characteristics, the present invention will be described hereinafter by comparison with a conventional epitaxial growth technique.

FIG. 9(a) is a diagram showing a conventional method using a low-temperature deposition buffer layer. This method comprises subjecting the low-temperature deposition buffer layer to thermal treatment at a high temperature to form a fine insular structure, and growing a GaN single crystal on the structure at a high temperature. Additionally, as described in the aforementioned document 1, the insular structure plays a role of performing the crystal growth at a low temperature to realize uniform deposition on the surface, and consciously forming a portion relatively weak in interatomic bond to moderate a large lattice mismatch. Specifically, the aforementioned insular structure needs to be deposited at a temperature as low as about 500° C. Therefore, the insular structure has a polycrystalline structure, and includes a large number of defects or stacking faults, and crystal axes are sometimes misaligned.

On the other hand, in the present invention the insular crystal includes the single-crystal layer, and in this respect the present invention is different from the aforementioned related art. Specifically, in the present invention the insular crystal is formed at a temperature such that the single-crystal layer is included, and GaN is formed at a high temperature, for example, of 900° C. or more. Since the insular crystal in the present invention includes such single-crystal layer, during the growth of the epitaxial layer on the base substrate, the epitaxial growth preferentially proceeds from the single-crystal layer portion with little crystal defect, and the crystal defect in the epitaxial layer can remarkably be reduced.

Moreover, in the present invention, as compared with the aforementioned related art, an insular crystal density on the base substrate is reduced and a particle size of the insular crystal is increased (FIGS. 9(a), (b)). By reducing the insular crystal density and increasing an average interval between the adjacent insular crystals, a boundary generated by collision of the epitaxial layers with the respective insular crystals as the starting points can be reduced, and the crystal defect can further be reduced. Moreover, by relatively enlarging the respective insular crystals, the epitaxial layers with the respective insular crystals as the growth starting points coalesce, and formation of a flat epitaxial layer is promoted.

On the other hand, also in an initial stage of usual epitaxial growth, insular structures are formed apart from one another. However, such insular structure only appears in a transient period during the epitaxial growth, and it is difficult to control distribution and density of the structure in a range suitable for the crystal defect reduction. Moreover, it is known that the insular structure is formed by occurrence of nucleus growth in the crystal defect or the contamination place of the base substrate or the base layer, crystal axis directions are misaligned, the insular crystal itself includes the crystal defect in many cases, and the structure is not suitable for obtaining the epitaxial layer with little crystal defect. Furthermore, as described above, the insular crystal is easily generated in the crystal defect or the contamination place, and also from this respect, it is difficult to control the distribution or the density in the range suitable for the crystal defect reduction.

On the other hand, the present invention relates to a technique of forming the insular crystal of the structure suitable for reducing the crystal defect in the epitaxial layer, that is, the insular crystal comprising the single-crystal layer on the base substrate for the crystal growth, and using this to form the epitaxial layer. Since the insular crystal in the present invention is formed on the base substrate for crystal growth, the distribution and density can be controlled in the range suitable for the crystal defect reduction, and additionally each crystal axis direction of the single-crystal layer can substantially agree with each crystal axis direction of the epitaxial crystal layer, so that the epitaxial growth from the insular crystal as the starting point can preferably proceed. As described above, according to the present invention, since the wafer with the insular crystal comprising the single-crystal layer disposed thereon is used as the base substrate for crystal growth, the crystal defect of the epitaxial crystal layer formed on the heterogeneous material substrate can remarkably be reduced without complicating the process.

### BRIEF DESCRIPTION OF THE DRAWINGS

FIGS. 1(a)-(f) are process sectional views showing a method of manufacturing a substrate according to the present invention.

FIGS. 2(a)-(e) are process sectional views showing the method of manufacturing the substrate according to the present invention.

FIGS. 3(a)-(f) are process sectional views showing the method of manufacturing the substrate according to the present invention.

FIGS. 4(a)-(g) are process sectional views showing the method of manufacturing the substrate according to the present invention.

FIGS. 5(a)-(f) are process sectional views showing the method of manufacturing the substrate according to the present invention.

FIGS. 6(a)-(f) are process sectional views showing the method of manufacturing the substrate according to the present invention.

FIGS. 7(a)-(d) are process sectional views showing the method of manufacturing the substrate according to the present invention.

FIGS. 8(a)-(d) are process sectional views showing the method of manufacturing the substrate according to the present invention.

FIGS. 9(a)-(b) are schematic sectional views of a base substrate for crystal growth according to the present invention (FIG. 9b) and a prior art (FIG. 9a).

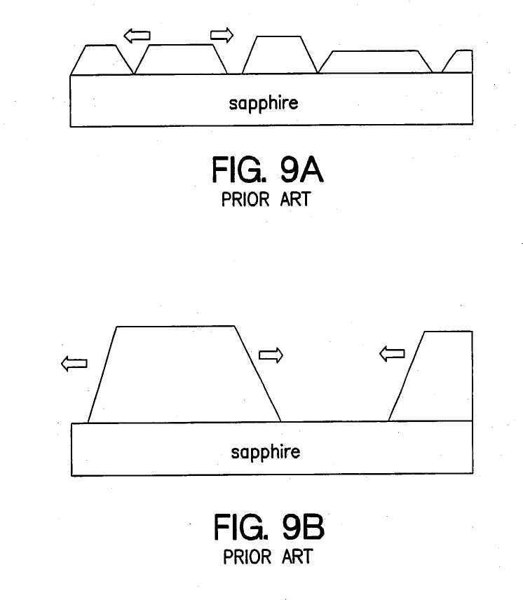

FIG. 10 is a chart showing a relation between a covering ratio of an insular crystal in the base substrate for crystal growth according to the present invention, and dislocation density in an epitaxial layer formed on the substrate.

FIGS. 11(a)-(b) are sectional views of a pendeo epitaxy method of the prior art.

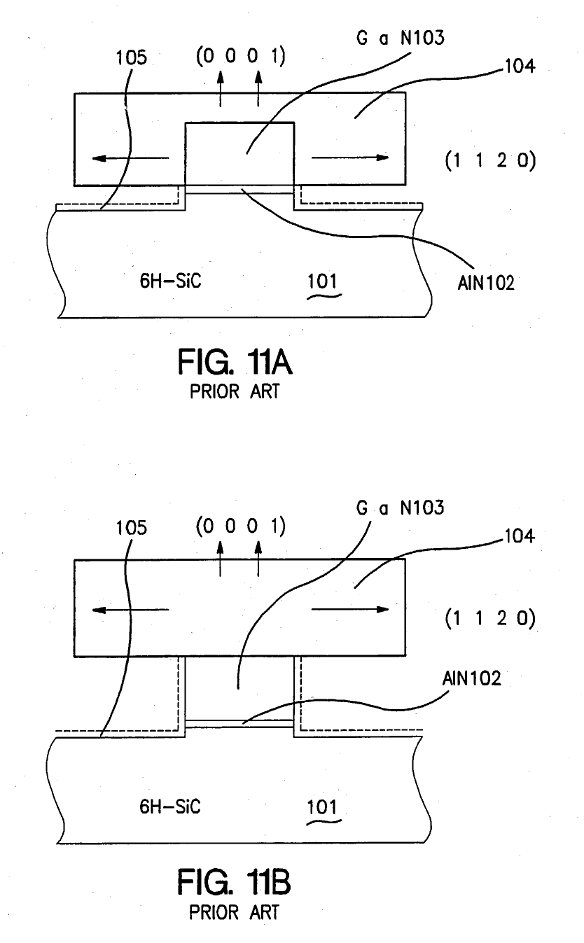

FIGS. 12(a)-(b) are sectional views of the pendeo epitaxy method of the prior art.

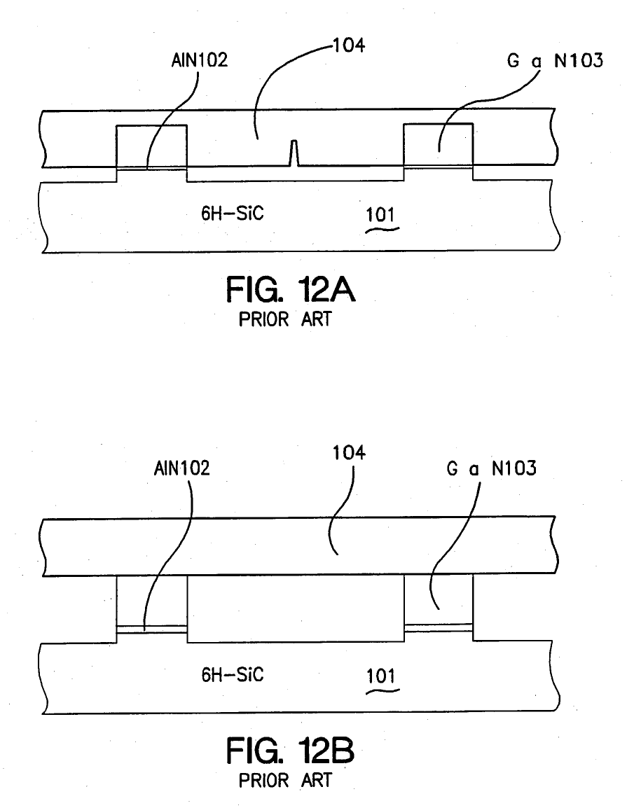

FIG. 13 is a photograph substituted for a drawing showing an appearance of the insular crystal of the base substrate for crystal growth according to the present invention.

FIGS. 14(a)-(b) are sectional views of a semiconductor laser prepared by applying the manufacturing method of the substrate according to the present invention.

FIG. 15 is a photograph substituted for a drawing schematically showing that the base substrate for crystal growth of the present invention is used to form the epitaxial layer.

### DETAILED DESCRIPTION OF THE PREFERRED EMBODIMENTS

An insular crystal in the present invention include a single crystal, but may be constituted of a lower polycrystalline layer formed on a base substrate, and an upper single-crystal layer of the same crystal system as that of an epitaxial crystal layer formed on the insular crystals. In this case, a single-crystal layer portion is formed on the polycrystalline layer forming a buffer layer, and formation of the single-crystal layer can preferably be performed.

Moreover, the insular crystal in the present invention may be constituted mainly of the single crystal. In this case, the crystal defect in the epitaxial layer can more effectively be reduced.

The insular crystal in the present invention is preferably formed directly on the base substrate. The insular crystal can also be formed on the base substrate via another layer, but in this case, a process becomes intricate.

The epitaxial layer formed after the formation of the insular crystal is preferably thickened until a shape of the insular crystal cannot be recognized and a smooth surface can be obtained. The thickness of the epitaxial layer is preferably larger than at least an average height of the insular crystals, and preferably ten times or more as large as the average height of the insular crystals. In this case, the epitaxial layer preferable for forming devices such as a semiconductor laser can be formed.

In the base substrate for crystal growth of the present invention, the base substrate can be constituted to have a concave/convex shape, and the insular crystal is formed on a convex portion of the concave/convex shape. The base substrate constituted in this manner can be prepared by etching the surface of a base substrate in a region in which no insular crystal is formed after the formation of the insular crystal. For example, during the formation of the insular crystal layer by etching the buffer layer, when the surface of the base substrate is locally exposed and subsequently the etching is further continued (over-etching), both the size and height of the insular crystal decrease, the base substrate is locally etched, and a groove is formed. By forming the groove, during the formation of the epitaxial layer, the crystal defect can further effectively be prevented from being transmitted from the base substrate, and the effect of reducing the crystal defect in the epitaxial layer becomes more remarkable.

Additionally, when the aforementioned groove is formed, the groove remains a hollow as it is even after growing of the epitaxial layer. This means that lateral growth using the insular crystal as a crystal nucleus rapidly occurs in an initial stage of epitaxial growth, and clearly indicates that the fast lateral growth itself in the growth initial stage results in a flatted epitaxial layer. Since the lateral growth is dominant in this manner, the epitaxial growth layer fails to succeed a crystal mode of a heterogeneous base substrate, or fails to be much influenced.

As described above, even after the growth of the epitaxial layer the groove remains the hollow as it is, and the groove therefore plays a great role also when the base substrate needs to be removed after the epitaxial growth. When the base substrate is removed, a method of dipping the wafer in an etching liquid is usually used, but in this case, the etching liquid penetrates into the groove, and it becomes easy to separate the epitaxial growth layer from the heterogeneous base substrate.

In the present invention, an upper limit of the covering ratio of a plurality of insular crystals, that is, a ratio of an area occupied by the insular crystals to a surface area of the base substrate is preferably set to 60% or less, more preferably 50% or less. When the covering ratio is too large, the effect of reducing the crystal defect in the epitaxial layer is insufficiently obtained in some cases. By setting the covering ratio to be low to some degree, a boundary generated when the epitaxial layers with the respective insular crystals as the growth starting points collide against each other can be reduced, and the crystal defect can effectively be reduced. On the other hand, a lower limit of the covering ratio is preferably set to 0.1% or more, more preferably 1% or more. When the covering ratio is too low, the epitaxial layer fails to be sufficiently flat.

In the present invention, the lower limit of an average particle size of a plurality of insular crystals is preferably set to 0.1 μm or more, more preferably 1 μm or more. On the other hand, the upper limit is preferably set to 10 μm or less, more preferably 5 μm or less. With the aforementioned average particle size, the flat epitaxial layer with little crystal defect can preferably be formed.

In the present invention, the lower limit of an average interval of a plurality of insular crystals is preferably set to 10 μm or more, more preferably 20 μm or more. Here, the average interval indicates an average value of a distance between adjacent insular crystals. When the average interval is too small, the reduction effect of the crystal defect in the epitaxial layer can insufficiently be obtained in some cases. By setting the average interval to be large to some degree, the aforementioned boundary can be reduced, and the crystal defect can effectively be reduced. On the other hand, the upper limit is preferably set to 500 μm or less, more preferably 100 μm or less. When the average interval is too large, the epitaxial layer is insufficiently flatted in some cases. Additionally, when the average interval is of the order of 100 μm, the epitaxial layer by lateral growth is sufficiently flatted. This is confirmed by an experiment example in which the insular crystal layer of GaN is formed by etching the buffer layer, and subsequently the groove is formed in the base substrate by over-etching. In this experiment example, the average interval of the insular crystals is set to be of the order of 100 μm, but the groove is left as it is even after the formation of the GaN epitaxial layer. Therefore, even when the average interval is set to be large as described above, the flatting of the epitaxial layer by the lateral growth occurs.

In the present invention, the upper limit of a number density of a plurality of insular crystals is preferably set to 10⁻² crystals/μm² or less, more preferably 10⁻³ crystals/μm² or less. When the number density is too large, the reduction effect of the crystal defect in the epitaxial layer is insufficiently obtained in some cases. By setting the number density to be small to some degree, the aforementioned boundary can be reduced, and the crystal defect can effectively be reduced. On the other hand, the lower limit is preferably set to 10⁻⁵ crystals/μm² or more, more preferably 10⁻⁴ crystals/μm² or more. When the number density is too small, the epitaxial layer becomes insufficiently flat in some cases.

A thickness of the buffer layer is not particularly limited. The buffer layer is usually deposited in a thickness of the order of several thousands of angstroms to several micrometers, and is etched to form the insular crystal. Generally, the buffer layer is formed of fine crystal grains, and with an increase of the thickness of the buffer layer the crystal grains become large. Therefore, the density of the insular crystals after etching tends to be lowered, and sufficient etching results in a low density, so that the insular crystals are formed with a large distance between islands. Conversely, when a thin buffer layer is prepared to perform the etching, because of small crystal grains, the insular crystals can be formed with a high density and with a narrow interval between the adjacent islands. The size of the crystal grain can freely be selected as a measure from the order of a film thickness of the buffer layer to the diameter of several angstroms, and the interval between the adjacent islands can also freely be selected because the crystal with a small particle size vanishes with the progress of etching. Additionally, with respect to the particle size and interval of the insular crystal, by setting conditions of the buffer layer to be constant and monitoring light scattering, the insular crystal with a constant property can be formed substantially with industrially satisfactory reproducibility.

In the present invention a growth temperature of the insular crystal or the buffer layer for forming the insular crystal is preferably set to be a temperature at which a material constituting the layer is suitable for forming a crystal layer with a large grain size. For example, in case of GaN, the temperature is preferably in a range of 900 to 1150° C., more preferably 950 to 1050° C. In this case, the insular crystal including the single-crystal layer can steadily be formed.

A relation between covering ratio R, and insular crystal average particle size and average interval will next be described. The island shape of the insular crystal and the interval between the adjacent islands are actually random, but the following consideration is based on an assumption that these have average values. Assuming that the average particle size of the insular crystal is D, and density is N, the covering ratio R has a relation of R=(πD²/4)N, and an average interval L between the insular crystals with a sufficiently large density N is L=N^{-1/2}. By using this relation, with respect to an experimentally obtained periphery, calculation results of the relation are shown in the following table.

TABLE 1

| N | L | D(μm) | | | |
|---|---|---|---|---|---|
| (μm⁻²) | (μm) | R = 0.0001 | R = 0.001 | R = 0.01 | R = 0.1 |
| 10⁻⁵ | 320 | 3.6 | 11 | 36 | 110 |
| 10⁻⁴ | 100 | 1.1 | 3.6 | 11 | 36 |
| 10⁻³ | 32 | 0.36 | 1.1 | 3.6 | 11 |
| 10⁻² | 10 | 0.11 | 0.36 | 1.1 | 3.6 |
| 10⁻¹ | 3.2 | 0.036 | 0.11 | 0.36 | 1.1 |
| 1 | 1 | 0.011 | 0.036 | 0.11 | 0.36 |

Preferred embodiments of the present invention will be described hereinafter.

<First Embodiment>

First, on a base substrate, a buffer layer of a crystal system different from that of the base substrate is formed. The buffer layer is formed by coalescence of fine crystal grains, and is in the same crystal system as that of an epitaxial layer formed on the buffer layer. A lattice constant of the buffer layer is set to be a value substantially close to the value of the lattice constant of the epitaxial layer.

Thereafter, wet etching is performed from the surface of the buffer layer. Here, since the buffer layer contains a large number of crystal grain boundaries, the wet etching usually fails to flatly proceed. It is easily understood that for an etching speed, the etching proceeds fast in a crystal grain boundary, and a crystal grain portion is left. The buffer layer remains as an insular crystal on a heterogeneous base substrate in this manner. Since the insular crystal is formed as described above, a single-crystal structure is provided.

On the heterogeneous base substrate with the insular crystal formed thereon, a predetermined epitaxial growth is performed. When a thickness exceeds the thickness about several times as large as the thickness (height) of the insular crystal, an epitaxial growth layer with a flat surface is obtained.

<Second Embodiment>

The buffer layer formed directly on the heterogeneous base substrate is usually provided with an insufficiently satisfactory crystal property, and is usually constituted of a crystal grain with a fine diameter of several hundreds of nanometers or less in many cases. Therefore, in order to form the insular crystal including the single-crystal layer, effective is a method comprising forming a first buffer layer on the base substrate, subsequently forming a second buffer layer on the first buffer layer with a temperature higher than a first buffer layer forming temperature, and then wet-etching these layers.

For example, after the first buffer layer is formed in a thickness of about 0.1 μm, the second buffer layer is formed in a thickness of several micrometers to about dozen micrometers at the temperature higher than the first buffer layer forming temperature. In this case, by performing the wet etching after formation of the second buffer layer, the insular crystal provided with an upper layer portion with a relatively large grain size can be formed. In this case, when the etching is performed little longer, small crystal grains are organized, and as a result the upper portion of the insular crystal forms a single crystal. Consequently, at least upper portions of most of the insular crystals form the single crystal. When a large number of insular crystals having the single-crystal layers on the upper portions thereof are formed on a wafer and the wafer is used as a base substrate for crystal growth, epitaxial growth proceeds using the single crystal portion of the insular crystal as the nucleus, and the epitaxial layer little in crystal defect and remarkably high in crystal property can therefore be obtained.

The fact that the crystal defect can remarkably be reduced by using the base substrate with the insular crystal including the single-crystal layer formed thereon to perform the epitaxial growth has been confirmed by the present inventor et al. according to an experiment (described later in an example). From the experiment result, the crystal grain boundary can be expected to be related as a large cause of dislocation entering the epitaxial layer.

A concrete example of a method of forming the first and second buffer crystal layers in the present embodiment will be described hereinafter.

(Forming Conditions of First Buffer Layer)

For example, the forming of the first buffer layer onto the heterogeneous substrate such as a sapphire (0001) plane is performed by a metalorganic vapor phase epitaxy (MOVPE) method. Here, the first buffer layer is preferably formed at a temperature lower than the temperature at which the crystal second buffer layer, or the epitaxial layer formed on the second buffer layer is formed, and the temperature is preferably on the order of 400 to 600° C. For film forming source gases, when the first buffer layer is constituted of GaN, for example, trimethylgallium is used as a Ga source gas, and ammonia is used as a nitrogen source gas. The thickness of the first buffer layer is not particularly limited, but is, for example, of the order of 20 to 200 nm.

(Forming Conditions of Second Buffer Layer)

The second buffer layer is formed by a hydride VPE method or the like. The growth temperature is preferably set to be higher than that of the first buffer layer, preferably in a range of 900 to 1100° C., more preferably 950 to 1000° C. The thickness of the second buffer layer is, for example, in a range of 500 to 5000 nm.

A growth speed of the second buffer layer is preferably set to be slower than that of the epitaxial layer formed thereafter. In this case the crystal defect of the obtained epitaxial layer can more effectively be reduced. Therefore, a raw material supply amount during the growth of the second buffer layer is preferably set to be smaller than that during the growth of the epitaxial layer.

<Third Embodiment>

In <the first embodiment>, after forming the buffer layer, the etching was performed to form the insular crystal. As described later in the example, the insular crystal can directly be formed by a, deposition method on appropriate conditions. In the present embodiment, for the deposition of the insular buffer layer, a material in the same crystal system as that of a desired epitaxial crystal and with a close lattice constant is deposited at a relatively low temperature in an appropriate thickness, and the growth temperature is raised as occasion demands to form the second buffer layer so that the crystal particle size is enlarged. Insular formation can be performed by a process of raising the temperature after the formation of the first buffer layer, or by changing epitaxial growth conditions to etching conditions after lamination to the second buffer layer.

Thereafter, the desired epitaxial growth is performed, and the subsequent circumstances are similar to those described in <the first embodiment>. The particle size or interval of the insular crystal can also be adjusted by the condition, growth temperature or material gas supply speed, and the like during the formation of the buffer layer.

<Fourth Embodiment>

This is a modification of <the third embodiment>, but when the heterogeneous base substrate is easily thermally decomposed, or when chemical decomposition is caused by a material gas or the like for forming the desired epitaxial layer, in a process of forming the buffer layer, decomposition locally occurs in the heterogeneous base substrate and the insular crystal is simultaneously formed. As an example of the heterogeneous base substrate, when the desired epitaxial layer is made of a nitride-based material of an element in the group III, compound semiconductors of elements in the groups III-V such as GaAs, GaP and GaAsP or silicon are most easily available and usable. Particularly, when the heterogeneous base substrate is used, there is a great advantage that the base substrate can easily be removed by etching after the epitaxial layer growth. When the desired epitaxial layer is made of the group III-nitride material, InP is inappropriate because of excessively severe thermal decomposition during the epitaxial growth. Generally a melting point of the heterogeneous base substrate for use is preferably higher than the desired epitaxial growth temperature by 200 degrees or more.

After the formation of the insular crystal, the desired epitaxial growth is performed, but as in the case of <the second embodiment>, the subsequent circumstances are basically similar to those described in <the first embodiment>. Moreover, this is similar to the second embodiment in that the particle size and interval of the insular crystal can be adjusted by buffer layer forming conditions.

### EXAMPLES

The present invention will be described in more detail by way of examples.

In the examples, after using a 1:1 mixture liquid (volume ratio) of phosphoric acid and sulfuric acid to wet-etch the obtained epitaxial layer, an etch pit density was measured by observation of a film surface using a transmission electron microscope. The etch pit density is an indication of a dislocation density in the epitaxial layer.

Moreover, in the respective examples, the insular crystal is formed, and a profile of either insular crystal is within the following range.

Covering ratio with respect to the base substrate: 0.1% to 60% (excluding a covering ratio of 90% in Example 1)

Average particle size: 0.1 to 10 μm

Average interval between adjacent insular crystals: 10 to 500 μm

Number density: 10⁻⁵ to 10⁻² crystals/μm²

### Example 1

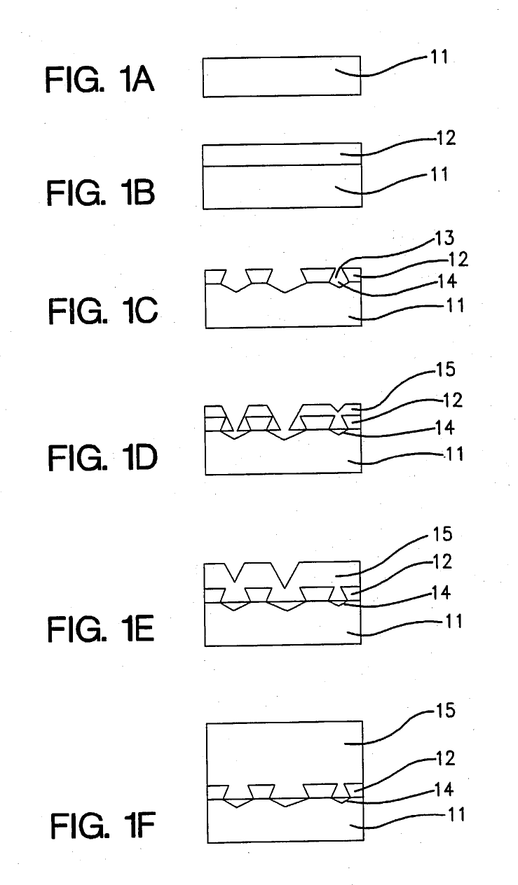

The present example will be described with reference to FIG. 1. In the present example, a (0001) plane sapphire (Al₂O₃) substrate 11 is used as a substrate (FIG. 1(a)). A GaN film 12 having a thickness of 1.5 μm is formed on the substrate 11 by a metalorganic vapor phase epitaxy (MOVPE) method in which trimethylgallium (TMG) is used as a raw material of an element in the group III, an ammonia (NH₃) gas is used as a raw material of an element in the group V, and a hydrogen gas (H₂) and a nitrogen gas (N₂) are used as carrier gases (FIG. 1(b)). A procedure of forming the GaN film 12 is as follows. First, the sapphire substrate 11 with a cleaned surface is set in a growth region of an MOVPE apparatus. Subsequently, in an H₂ gas atmosphere, temperature is raised to 1050° C., and heat treatment is performed on the surface of the substrate 11. Next, the temperature of the substrate 11 is lowered to 500° C. After the temperature is stabilized, TMG and NH₃ are supplied, so that a GaN layer having a thickness of 20 nm is formed. In this case, supply amounts of TMG and NH₃ are 10 μmol/min and 4000 cm³/min, respectively. Furthermore, while the NH₃ gas is supplied, the temperature of the substrate 11 is raised to 1050° C. After the temperature is stabilized, TMG is supplied, whereby a GaN film 12 having a thickness of about 1.5 μm is formed. In this case, the supply amounts of TMG and NH₃ are 50 μmol/min and 4000 cm³/min, respectively. After the GaN film 12 is formed, in an NH₃ atmosphere, cooling is made to lower the temperature to about 600° C. When the temperature of the substrate 11 reaches about 500° C., the supply of the NH₃ gas is stopped. Then, the H₂ gas is switched to an N₂ gas, the cooling is performed to a normal temperature, and the substrate is removed from the MOVPE apparatus.

Next, the GaN film 12 on the substrate 11 is insularly etched by a solution (FIG. 1(c)). In the etching to form the GaN film 12 in the island shape, a 1:1 (volume ratio) mixture liquid of phosphoric acid and sulfuric acid from which moisture has been evaporated is used at a raised temperature of 270° C. In the etching for 30 minutes, the GaN film 12 is removed in the island shape, and an opening 13 is formed. Under the condition, a proportion of the opening 13 formed in the GaN film 12 is about 50%. Since this solution can also etch sapphire, a groove 14 is formed on the surface of the sapphire substrate 11 in a region of the opening 13 from which the GaN film 12 is removed.

Furthermore, a GaN film 15 is formed on the GaN film 12 formed in the island shape by the hydride VPE method (HVPE) in which gallium chloride (GaCl) which is a reaction product of gallium (Ga) and hydrogen chloride (HCl) is used as a raw material of an element in the group III, and an ammonia (NH₃) gas is used as a raw material of an element in the group V (FIGS. 1(d) to 1(f)). A procedure of forming the GaN film 15 comprises setting the substrate prepared as described above on an HVPE apparatus, supplying the H₂ gas while raising the temperature to 600° C., and further supplying the NH₃ gas while raising the temperature to 1040° C. After the growth temperature is stabilized, GaCl is supplied to grow GaN. In this case, the amount of HCl to be supplied onto Ga is 40 cm³/min, and the supply amount of the NH₃ gas is 1000 cm³/min. In this growth, since the growth of GaN scarcely occurs on the surface of the groove 14 of the substrate 11 in the opening 13, the epitaxial growth is performed on the surface of the GaN film 12 and the side surface of the opening 13 (FIG. 1(d)). As the growth of the GaN film 15 proceeds, the region of the opening 13 is gradually embedded. When the growth is further continued, the opening 13 is completely embedded (FIG. 1(e)). Furthermore, the epitaxial growth is continued until irregularities generated on the surface of the GaN film 15 are flatted. The GaN film 15 having a thickness of 150 μm is formed by the epitaxial growth for 2.5 hours. Additionally, the groove 14 remains even after the forming of the GaN film 15 by the epitaxial growth is completed (FIG. 1(f)). After the GaN film 15 is formed, the NH₃ gas is supplied, cooling is performed to obtain about 600° C., and the supply of the NH₃ gas is stopped. Thereafter, the cooling is performed to obtain the normal temperature, the H₂ gas is switched to the N₂ gas, and the substrate is removed from the HVPE apparatus.

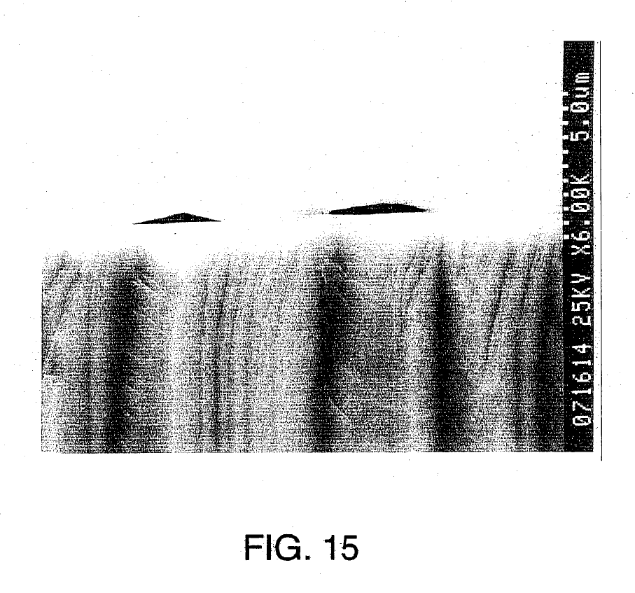

The GaN film 15 could be formed on the substrate 11 without any crack or fracture which causes a problem in a directly grown film as thick as about 8 μm or more. An SEM photograph corresponding to a state of FIG. 1(f) is shown in FIG. 15. FIG. 15 shows a cross section in the vicinity of an interface of the GaN film 15 and the sapphire substrate 11. A lower part of the drawing corresponds to the sapphire substrate 11 of FIG. 1(f), and an upper part of the drawing corresponds to the GaN film 15 of FIG. 1(f). Moreover, a triangular portion in the middle of the drawing shows the groove 14 of FIG. 1(f). It is seen from the drawing that the opening 13 (FIG. 1(f)) formed by solution etching is completely embedded and that no growth occurs in the groove 14 formed in the surface of the sapphire substrate 11. Furthermore, when the etch pit density of the GaN film 15 surface by the solution was measured, a value was 1×10⁷/cm², and was equivalent to the value of the GaN film formed by selective growth using a mask.

Since the GaN film 15 formed in the present example has little defect, and no crack is generated, properties can be enhanced by growing a laser structure, FET structure, HBT and another device structure on the GaN film 15.

Furthermore, by peeling the sapphire substrate 11 from the substrate by grinding, chemical etching, laser, and the like, the GaN film 15 can be used as a substrate crystal.

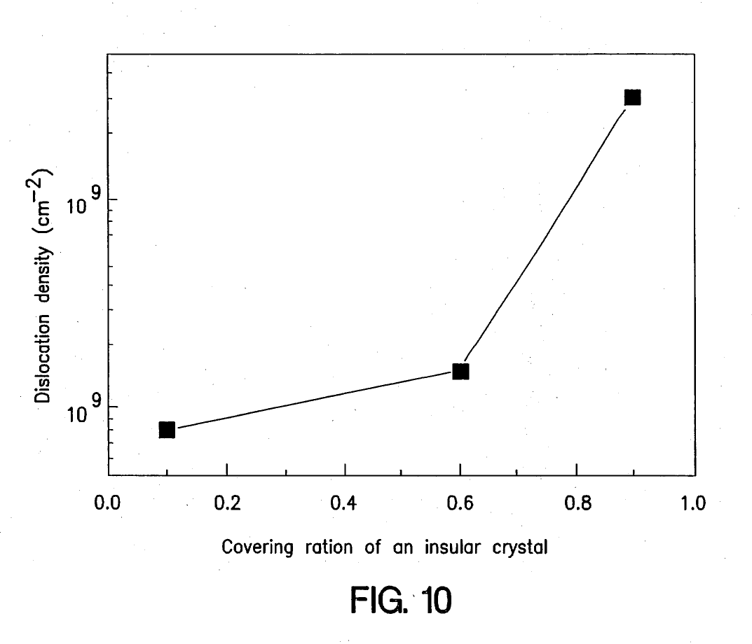

Next, a result is shown in FIG. 10 in which a method similar to the method of the present example was used and a relation was obtained between the covering ratio of an insular crystal (a value obtained by dividing an area occupied by the insular crystal by a surface area of a base substrate) and a dislocation density in the epitaxial layer grown from the insular crystal. Here, the covering ratio of the insular crystal was controlled by adjusting an etching time by a mixture liquid of phosphoric acid and sulfuric acid. It is seen from the drawing that by setting the covering ratio to 0.6 or less, the dislocation density can remarkably be reduced.

In the present example, the GaN film 15 was formed by using the hydride VPE method fast in the growth rate , but even when the metalorganic vapor phase epitaxy method (MOVPE) is used, a similar effect can be obtained. Moreover, the sapphire substrate 11 was used as the base substrate, but even when an Si substrate, ZnO substrate, SiC substrate, LiGaO₂ substrate, MgAl₂O₄ substrate, NdGaO₃ substrate, GaAs substrate, or the like is used, the similar effect can be obtained. In the present example, the GaN film formed on the substrate 11 was used, but even when an AlₓIn_{y}Ga_{z}N film (x+y+z=1), AlₓGa₁₋ₓN film (x≦1), InₓGa₁₋ₓN film (x≦1), InN film, InₓGa₁₋ₓAs film (x≦1), or InₓGa₁₋ₓP film (x≦1) is formed, the similar effect is obtained. In the present example, the epitaxial growth of the GaN film 15 has been described, but even when an AlₓIn_{y}GaₓN film (x+y+z=1 (0≦x, y, z, ≦1), AlₓGa₁₋ₓN film (0≦x≦1), InₓGa₁₋ₓN film (x≦1), InN film, InₓGa₁₋ₓAs film (x≦1), or InₓGa₁₋ₓP film (x≦1) is subjected to the epitaxial growth, the similar effect can be obtained. Furthermore, even when impurities are doped, the similar effect can be obtained.

### Example 2

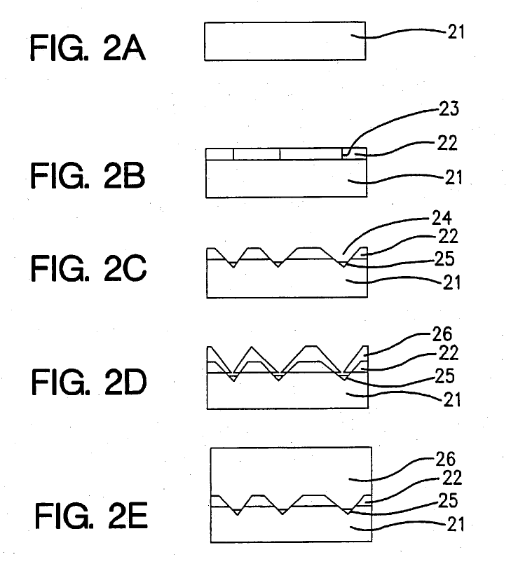

The present example will be described with reference to FIG. 2. In the present example, a (0001) plane sapphire (Al₂O₃) substrate 21 is used as a substrate (FIG. 2(a)). An Al_{0.2}Ga_{0.8}N film 22 having a thickness of about 2 μm with a crack 23 is formed on the substrate 21 by the MOVPE method in which trimethylgallium (TMG) is used as a raw material of an element in the group III, triethylaluminum (TMA) is used, an ammonia (NH₃) gas is used as a raw material of an element in the group V, and a hydrogen gas (H₂) and a nitrogen gas (N₂) are used as carrier gases (FIG. 2(b)). A procedure of forming the Al_{0.2}Ga_{0.8}N film 22 is as follows. First the sapphire substrate 21 with the cleaned surface is set in the growth region of the MOVPE apparatus. Subsequently, in the H₂ gas atmosphere, temperature is raised to 1050° C., and heat treatment is performed on the growth surface of the substrate 21. Subsequently, after the temperature is lowered to 500° C., and stabilized, TMG, TMA and NH₃ are supplied, and an AlGaN layer having a thickness of 20 nm is formed. The supply amounts of TMG, TMA and NH₃ are 10 μmol/min, 2 μmol/min and 3000 cm³/min, respectively. Furthermore, while supplying the NH₃ gas, the temperature of the substrate 21 is raised again to 1020° C. After the temperature is stabilized, TMG, TMA are supplied, and the Al_{0.2}Ga_{0.8}N film 22 having a thickness of about 1 μm is formed. In this case, the supply amounts of TMG, TMA and NH₃ are 50 μmol/min, 40 μmol/min and 4000 cm³/min, respectively. After the Al_{0.2}Ga_{0.8}N film 22 is formed, in the NH₃ atmosphere, cooling is performed to obtain about 600° C., and the supply of the NH₃ gas is stopped. Furthermore, the H₂ gas is switched to the N₂ gas, cooling is performed to obtain a normal temperature, and the substrate is removed from the MOVPE apparatus.

The crack 23 is generated in the Al_{0.2}Ga_{0.8}N film 22 formed as described above because of a difference of lattice multiplier from the sapphire substrate 21. Subsequently, an opening 24 and the groove 23 of the substrate 21 are formed by the solution on the Al_{0.2}Ga_{0.8}N film 22 on the substrate 21 (FIG. 2(c)). The etching liquid is obtained by mixing phosphoric acid (H₃PO₄) and sulfuric acid (H₂SO₄) at a ratio of 1:1.5 and used with a raised temperature of 280° C. Since the etching proceeds fast in a crack 23 region of the Al_{0.2}Ga_{0.8}N film 22, the opening 24 can be formed along the crack 23. Since the solution can also etch sapphire as in Example 1 described above, a groove 25 can be formed on a substrate 21 surface along the opening 24 of the Al_{0.2}Ga_{0.8}N film 22. Furthermore, a GaN film 26 is formed on the substrate 21 provided with the opening 24 and the groove 25 in the same manner as in Example 1 by the hydride VPE method (HVPE) in which gallium chloride (GaCl) which is a reaction product of gallium (Ga) and hydrochloride (HCl) is used as a raw material of an element in the group III and the ammonia (NH₃) gas is used as a raw material of an element in the group V (FIGS. 2(d), (e)). A procedure of forming the GaN film 26 comprises first setting the substrate prepared as described above on the HVPE apparatus, and supplying the H₂ gas while raising the temperature to 600° C. Furthermore, the NH₃ gas is supplied while raising the temperature to 1020° C. After the growth temperature is stabilized, GaCl is supplied to grow GaN. The amount of HCl to be supplied onto Ga is 40 cm³/min, and the supply amount of the NH₃ gas is 800 cm³/min. In the HVPE growth of GaN, since the growth fails to easily occur in the groove 25 of the opening 24, the growth is performed on the surface and side surface of the Al_{0.2}Ga_{0.8}N film 22 (FIG. 2(d)). When the epitaxial growth is further continued, the GaN film 26 fills the groove 25 region as in Example 1, and thereafter a flat surface can be formed (FIG. 2(e)). The GaN film 26 having a thickness of 300 μm is formed by the growth for four hours. Additionally, after the GaN film 26 is formed, the NH₃ gas is supplied, cooling is performed to obtain about 600° C., and the supply of the NH₃ gas is stopped. Thereafter, the cooling is performed to obtain the normal temperature, the H₂ gas is switched to the N₂ gas and the substrate is removed from the growth apparatus. The GaN film 26 on the substrate 21 was formed without any crack or fracture, as in Example 1. Moreover, when the etch pit density by the solution was measured, on the surface of the GaN film 26, the value was 1×10⁷/cm², and was equivalent to the value of the GaN film formed by the selective growth using the mask.

In the example, the AlGaN film 21 with an Al composition of 0.2 was used, but by changing the Al composition and film thickness, the amount and direction of the crack 23 can be determined. Moreover, a shape of the opening 24 can be controlled by the etching time, temperature, and mixture ratio of the solution.

According to the present example, the GaN film 26 with little crystal defect was obtained. In the present example, the Al_{0.2}Ga_{0.8}N film 22 was formed directly on the (0001) plane sapphire substrate, but even when a substrate material for forming an InₓGa₁₋ₓN film (1≦x≦0), GaN film, InGaAs film, ZnO film or SiC film is used on the sapphire substrate, the similar effect can be obtained. In the example, the (0001) sapphire substrate was used in the material of the substrate 11, but even when an Si substrate, ZnO substrate, SiC substrate, LiGaO₂ substrate, MgAl₂O₄ substrate, NdGaO₃ substrate, GaAs substrate, AlₓGa₁₋ₓN substrate (0≦x≦1), or the like is used, the similar effect can be obtained.

### Example 3

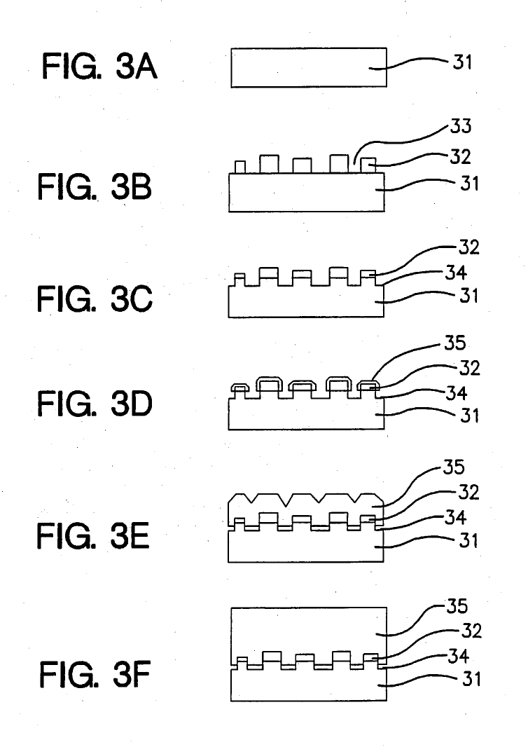

The present example will be described with respect to FIG. 3. In the present example, a (0001) plane sapphire substrate crystal is used as a substrate 31 (FIG. 3(a)). An insular GaN film 32 is formed on the substrate 31 (FIG. 3(b)). The insular GaN film 32 is formed by the hydride VPE method (HVPE) in which gallium chloride (GaCl) which is a reaction product of gallium (Ga) and hydrochloride (HCl) is used as a raw material of an element in the group III and an ammonia (NH₃) gas is used as a raw material of an element in the group V. A procedure of forming the GaN film 32 comprises first setting the substrate 31 on the HVPE apparatus, and supplying the H₂ gas while raising the temperature to 600° C. Furthermore, the NH₃ gas is supplied while raising the temperature to 1020° C. After the growth temperature is stabilized, HCl is supplied onto Ga to grow GaN. The supply amount of GaCl is 5 cm³/min, and the supply amount of the NH₃ gas is 500 cm³/min. The insular GaN film 32 with a height of about 2 μm was formed by the supply for one minute. After the GaN film 32 is formed, the NH₃ gas is supplied, cooling is performed to obtain about 600° C., and the supply of the NH₃ gas is stopped. Furthermore, the cooling is performed to obtain the normal temperature, the H₂ gas is switched to the N₂ gas and the substrate is removed from the growth apparatus. By employing the aforementioned film forming method, the GaN film 32 is formed in the island shape.

Subsequently, by etching the insular GaN film 32 and an exposed portion 33 of a substrate 31 surface, a groove 34 is formed in the substrate 11 (FIG. 3(c)). The etching was performed by a reactive ion etching method (RIBE) using a chlorine (Cl₂) gas. A forming procedure comprises setting the substrate 31 on an RIBE apparatus, and reducing a pressure in the apparatus to 0.6 mtorr. Subsequently, after supplying the chlorine (Cl₂) gas to stabilize the pressure in the apparatus, the etching is performed with an acceleration voltage of 500 V. The supply amount of the Cl₂ gas is 6 cm³/min, and the temperature of the substrate 31 is a normal temperature. By the etching for 20 minutes, the GaN film 32 and the exposed portion 33 of the substrate 31 are removed by about 1 μm, and the groove 34 can be formed on the substrate 31 surface of the exposed portion 33. After the etching, the supply of the acceleration voltage and the Cl₂ gas is stopped, and the N₂ gas is supplied to form an N₂ atmosphere in the apparatus. After sufficiently purging the Cl₂ gas, the pressure in the apparatus is set to a normal pressure, and the substrate 31 is removed.

Subsequently, a GaN film 35 is formed on the insular GaN film 32 again by the hydride VPE method (HVPE) (FIG. 3 (d, e, f)). As described above, a procedure of forming the GaN film 35 comprises first setting the substrate on the HVPE apparatus, and raising the temperature to 600° C. in the H₂ gas atmosphere. After the temperature of 600° C. is obtained, the NH₃ gas is supplied and the temperature is raised to 1020° C. After the growth temperature is stabilized, GaCl is supplied to grow GaN. The amount of HCl to be supplied onto Ga is 20 cm³/min, and the supply amount of the NH₃ gas is 1200 cm³/min. In a process of growth, the growth proceeds, as in Examples 1 and 2 described above. The GaN film 35 having a thickness of 250 μm was formed by the growth for five hours. After the GaN film 35 is formed, the NH₃ gas is supplied, cooling is performed to obtain about 600° C., and the supply of the NH₃ gas is stopped. Furthermore, the cooling is performed to obtain the normal temperature, the H₂ gas is switched to the N₂ gas and the substrate is removed from the growth apparatus.

According to the present example, the GaN film 35 with little crystal defect was obtained. In the present example, dry etching was used in the etching of sapphire, but the similar effect is obtained even by solution etching. Moreover, the hydride VPE method (HVPE) was used in a dot growth (insular growth) of the GaN film, but even when the film is formed by the MOVPE method, the similar effect is obtained. Moreover, the film is not limited to the GaN film, and as long as the insular growth is possible, the similar effect is obtained even from an AlₓGa₁₋ₓN film (0≦x≦1), InₓGa₁₋ₓN film (0≦x≦1), or InAlGaN film.

### Example 4

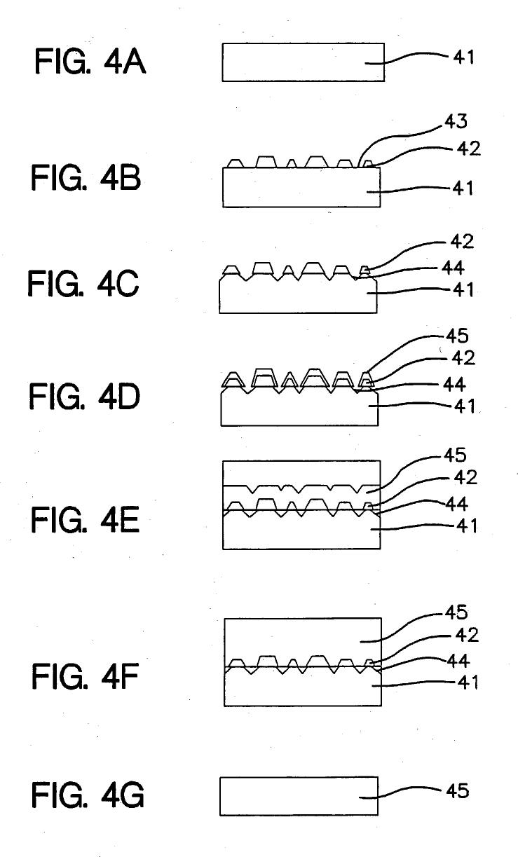

The present example will be described with reference to FIG. 4. In the present example, a (111) plane silicon (Si) substrate crystal is used as a substrate 41 (FIG. 4(a)). An insular GaN film 42 is formed on the substrate 41 (FIG. 4(a)). The insular GaN film 42 is formed by the hydride VPE method (HVPE) in which gallium chloride (GaCl) which is a reaction product of gallium (Ga) and hydrochloride (HCl) is used as a raw material of an element in the group III and an ammonia (NH₃) gas is used as a raw material of an element in the group V, as in Example 3. A procedure of forming the insular GaN film 42 comprises first setting the substrate 41 on the HVPE apparatus, and raising the temperature to 600° C. in the H₂ gas atmosphere. After the temperature of 600° C. is obtained, the NH₃ gas is supplied and the temperature is raised to 1050° C. After the growth temperature is stabilized, HCl is supplied onto Ga to grow GaN. The supply amount of HCl is 5 cm³/min, and the supply amount of the NH₃ gas is 300 cm³/min. The insular GaN film 42 with a height of about 1 to 2 μm can be formed by the supply for one minute (FIG. 4(b)). After the GaN film 42 is formed, the NH₃ gas is supplied, cooling is performed to obtain about 600° C., and the supply of the NH₃ gas is stopped. Furthermore, the cooling is performed to obtain the normal temperature, the H₂ gas is switched to the N₂ gas and the substrate is removed from the growth apparatus.

Subsequently, an exposed region 43 on a substrate 41 surface is subjected to solution etching by the solution to form a groove 44 (FIG. 4(c)). The groove 44 in the substrate 41 surface was formed by wet etching using a mixture liquid of nitric acid and hydrofluoric acid (nitric acid:hydrofluoric acid:water=1:1:2, volume ratio).

Furthermore, a GaN film 45 is formed on the insular GaN film 42 using the hydride VPE method (HVPE) in which gallium chloride (GaCl) which is a reaction product of gallium (Ga) and hydrochloride (HCl) is used as the group III raw material and the ammonia (NH₃) gas is used as the group V raw material (FIG. 4(d)). A procedure of forming the GaN film 45 comprises setting the substrate on the HVPE apparatus, raising the temperature to 650° C. in the H₂ gas atmosphere, supplying the NH₃ gas and raising the temperature to 1000° C. After the growth temperature is stabilized, GaCl is supplied to grow GaN. The supply amount of HCl is 20 cm³/min, and the supply amount of the NH₃ gas is 1000 cm³/min. In the growth, the growth of GaN is not easily performed in the groove 44 formed in the substrate 41. Therefore, GaN preferentially grows on the surface and side surface of the insular GaN film 42 (FIG. 4(e)). When the growth is continued, the GaN film 45 grown from the adjacent insular GaN film 42 fills the exposed region 43, and a hollow is formed in the groove 44 formed in the substrate 41 surface (FIG. 4(e)). Furthermore, when the epitaxial growth is continued in the same manner as in Examples 1, 2, 3 described above, a GaN film 45 surface can be flatted (FIG. 4(f)). The GaN film 45 having a thickness of 400 μm was formed by the growth for eight hours. After the GaN film 45 is formed, the NH₃ gas is supplied, cooling is performed to obtain about 600° C., and the supply of the NH₃ gas is stopped. Furthermore, the cooling is performed to obtain the normal temperature, the H₂ gas is switched to the N₂ gas and the substrate is removed from the growth apparatus. The GaN film 45 on the taken substrate 41 was formed without any crack or fracture, as in Example 1.

Subsequently, by removing the substrate 41, and abrading and flatting a back surface, the GaN film 45 can be formed as a simple-body substrate crystal (FIG. 4(g)). Etching removal of the substrate is performed using the mixture liquid of nitric acid and hydrofluoric acid. By dipping the substrate in the 1:1 mixture liquid for 24 hours, the substrate 41 was removed, and the abrading and flatting were performed. Since this mixture liquid dissolves silicon, but hardly etches the GaN film 45, the silicon substrate as the base substrate can preferably be removed.

In the present example, the (111) plane silicon substrate was used in the substrate crystal 41, but even when a (111) plane slightly inclined in an arbitrary direction, a (100) plane or another plane is used, the similar effect is obtained. The shape and size of the groove differ with the substrate plane for use, but in either case, a satisfactory epitaxial layer can be obtained.

Furthermore, the structure is not limited to the silicon substrate, and even when a GaAs substrate, GaP substrate, ZnO substrate, substrate material with a GaAs film formed on a Si substrate, or another material is used, the satisfactory epitaxial layer can be obtained.

### Example 5

In the present example, the process of forming the epitaxial layer described in Example 2 is repeated a plurality of times.

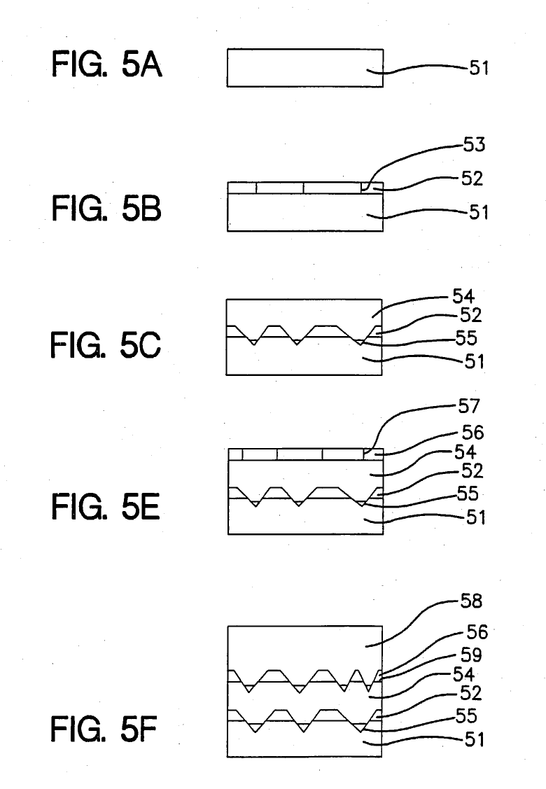

The present example will be described with reference to FIG. 5. In the present example, processes of FIGS. 2(a) to (e) described in Example 2 are first performed. Specifically, an Al_{0.2}Ga_{0.8}N film 52 (FIG. 5(b)) with a crack 53 is formed on a (0001) plane sapphire (Al₂O₃) substrate 51 (FIG. 5(a)). Subsequently, after wet etching is used to form a groove portion 55 in the substrate 51, the hydride VPE method (HVPE) is used to form a GaN film 54 (FIG. 5(c)). In this case the groove 55 remains on the substrate.

Subsequently, the aforementioned process is again repeated. Specifically, after forming an Al_{0.2}Ga_{0.8}N film 56 with a crack 57 on the GaN film 54 (FIG. 5(d)), and using the wet etching to form a groove portion 59 in the GaN film 54, the hydride VPE method (HVPE) is used to form a GaN film 58 (FIG. 5(e)).

As described above, the GaN film 58 with a remarkably reduced crystal defect is obtained.

### Example 6

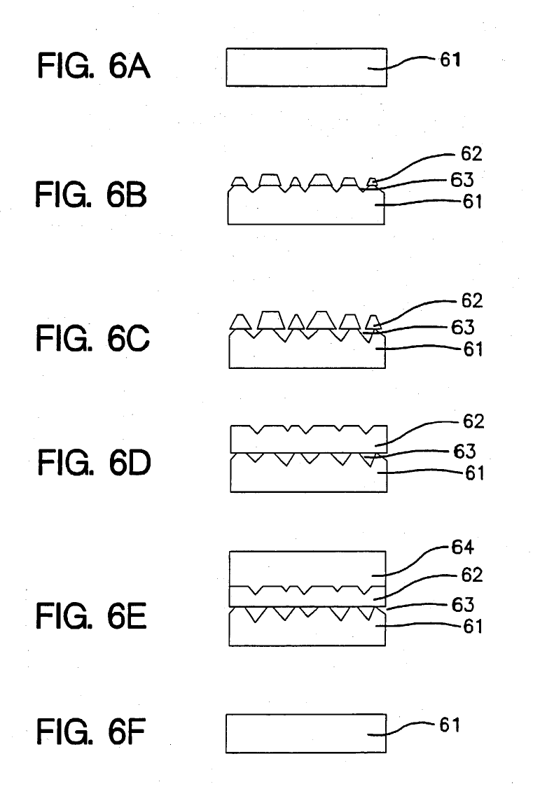

The present example will be described with reference to FIG. 6. In the present example, a GaAs substrate crystal with a (100) plane inclined at an angle of 2 degrees in a [110] direction is used as a substrate 61 (FIG. 6(a)). An insular GaN film 62 is formed on the substrate 61 using the hydride VPE method (HVPE) in which gallium chloride (GaCl) which is a reaction product of gallium (Ga) and hydrogen chloride (HCl) is used as a raw material of an element in the group III and an ammonia (NH₃) gas is used as a raw material of an element in the group V, and simultaneously an etching groove 63 is formed in a substrate 61 surface (FIG. 6(b)). A procedure of forming the insular GaN film 62 and the groove 63 on the substrate 61 surface comprises setting the substrate 61 on the HVPE apparatus, raising the temperature to 700° C. in the H₂ gas atmosphere, stabilizing the temperature and supplying CaCl and the NH₃ gas to form the insular GaN film 62. The amount of HCl to be supplied onto Ga is 1 cm³/min, and the supply amount of the NH₃ gas is 1000 cm³/min. By the growth, the insular GaN film 62 is formed on the substrate 61 surface and the surface groove 63 is formed. When the growth of GaN proceeds, the insular GaN film 62 is enlarged, and the groove 63 on the substrate 61 surface is enlarged (FIG. 6(c)). When the growth further proceeds, coalescence with the adjacent insular GaN film 62 occurs. In a coalesced GaN film 62 region, the progress of the etching is stopped on the substrate 61 surface. Furthermore, the growth is continued, and the GaN film 62 completely covers the substrate 61 surface (FIG. 6(d)). Subsequently, the NH₃ gas is supplied while raising the temperature of the substrate 61 to 1000° C. After the temperature is stabilized, GaCl is supplied and a GaN film 64 is formed. The amount of HCl to be supplied onto Ga is 20 cm³/min, and the supply amount of the NH₃ gas is 1000 cm³/min. By the growth for six hours, the GaN film 64 having a thickness of 300 μm was formed (FIG. 6(e)). After the GaN film 64 is formed, the NH₃ gas is supplied, cooling is performed to obtain about 600° C., and the supply of the NH₃ gas is stopped. Furthermore, the cooling is performed to obtain the normal temperature, the H₂ gas is switched to the N₂ gas and the substrate is removed from the growth apparatus.

Subsequently, the substrate 61 is removed, and a simple body of the GaN film 64 is formed (FIG. 6(f)). The etching removal of the substrate 61 is performed using sulfuric acid. By dipping the substrate for 12 hours, the substrate 61 was removed, and the abrading was performed to form the flat back surface. Since sulfuric acid can hardly etch the GaN film 64, the GaN film 64 can be taken as a simple-body film. According to the present example, the GaN film 64 with little crystal defect is obtained, and the removal of the substrate can easily be performed.

### Example 7

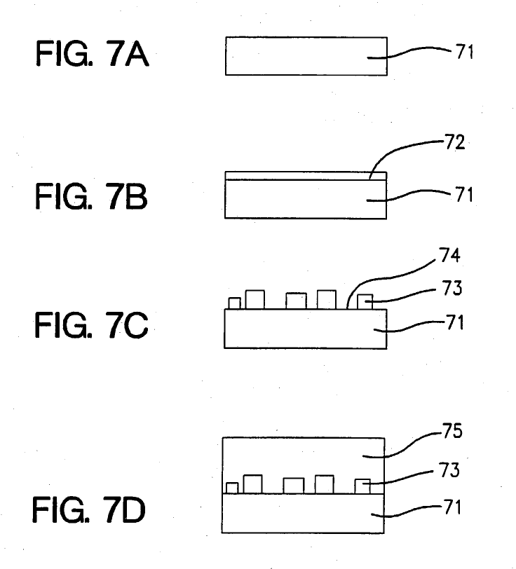

The present example will be described with reference to FIG. 7. In the present example, a (0001) plane sapphire (Al₂O₃) substrate 71 is used as a substrate (FIG. 7(a)). An insular GaN film 73 is formed on the substrate 71 by the metalorganic vapor phase epitaxy method (MOVPE) in which trimethylgallium (TMG) is used as a raw material of an element in the group III, an ammonia (NH₃) gas is used as a raw material of an element in the group V, and a hydrogen (H₂) and a nitrogen (N₂) are used as carrier gases (FIG. 7(c)).

A procedure of forming the GaN film 73 is as follows. First the sapphire substrate 71 with the cleaned surface is set in the growth region of the MOVPE apparatus. Subsequently, in a mixture atmosphere of H₂ and N₂ gases, temperature is raised to 1100° C., and the heat treatment is performed on the surface of the substrate 71. Subsequently, the temperature of the substrate 71 is lowered to 500° C. After the temperature is stabilized, TMG and NH₃ are supplied, and a GaN layer 72 having a thickness of 30 nm is formed (FIG. 7(b)). In this case, the supply amounts of TMG and NH₃ are 10 μmol/min and 5000 cm³/min, respectively, and the H₂ or the N₂ gas is supplied by 10000 cm³/min. After the forming of the GaN film 72, while supplying the NH₃ gas again, the temperature of the substrate 71 is raised again to 1080° C. In the temperature raising process, a part of the GaN film 72 is evaporated to form a particulate GaN film. In order to preferably form the particulate GaN film, the thickness of the GaN film is preferably appropriately set in accordance with a temperature raising speed, growth temperature, and H₂ or NH₃ partial pressure.

Thereafter, after the temperature is stabilized, TMG is supplied, and the epitaxial growth is performed. Thereby, the insular GaN film 73 having a facet is formed using the particulate GaN layer 72 as the nucleus. In this case, the supply amount of TMG is 90 μmol/min.

Thereafter, in the NH₃ atmosphere, cooling is performed to obtain about 600° C. When the temperature of the substrate 71 reaches about 500° C., the supply of the NH₃ gas is stopped, the supply of the H₂ gas is stopped, only the N₂ gas is supplied, cooling is performed to obtain the normal temperature, and the substrate is removed from the MOVPE apparatus.

Subsequently, a GaN film 75 is formed on the insular GaN film 73 (FIG. 1(d)). The GaN film 75 is formed by the hydride VPE method (HVPE) in which gallium chloride (GaCl) which is a reaction product of gallium (Ga) and hydrogen chloride (HCl) is used as the group III raw material and the ammonia (NH₃) gas is used as the group V raw material. A procedure of forming the GaN film 73 is as follows. First, the substrate 71 is set on the HVPE apparatus, and the H₂ gas is supplied while raising the temperature to about 600° C. Subsequently, the NH₃ gas is supplied while further raising the temperature to 1040° C. After the growth temperature is stabilized, GaCl is supplied to grow GaN. In this case the supply amount of GaCl is 20 cm³/min, and the supply amount of the NH₃ gas is 1000 cm³/min. In the HVPE growth, since the growth of GaN fails to easily occur in the exposed portion 75 on the sapphire substrate 71 surface, the epitaxial growth proceeds substantially only on the GaN film 73 surface. When the growth of the GaN film 75 proceeds, an exposed portion 74 is embedded. When the growth is further continued, the GaN film 75 surface is flatted. The GaN film 75 having a thickness of 300 μm can be formed by the epitaxial growth for five hours. After the GaN film 75 is formed, the NH₃ gas is supplied, cooling is performed to obtain about 600° C., the supply of the NH₃ gas is stopped, the cooling is further performed to obtain the normal temperature, the H₂ gas is switched to the N₂ gas and the substrate is removed from the HVPE apparatus.

The GaN film 75 on the substrate 71 was formed without any crack or fracture. Moreover, when the etch pit density by a phosphoric acid based solution on the GaN film 75 surface was measured, the value was 1×10⁷/cm².

In the present example, the GaN film 75 was formed using the hydride VPE method fast in the growth speed in the epitaxial growth of the GaN film 75, but the similar effect is obtained even when the metalorganic vapor phase epitaxy method (MOVPE) is used. Moreover, the sapphire substrate 71 was used, but even when the Si substrate, ZnO substrate, SiC substrate, LiGaO₂ substrate, MgAl₂O₄ substrate, NdGaO₃ substrate, GaP substrate, or the like is used, the similar effect can be obtained. In the present example, the GaN film formed on the substrate 71 was used, but even when the AlₓIn_{y}Ga_{z}N film (x+y+z=1), AlₓGa₁₋ₓN film (x≦1), InₓGa₁₋ₓN film (x≦1), InN film, InₓGa₁₋ₓAs film (x≦1), or InₓGa₁₋ₓP film (x≦1) is formed, the similar effect is obtained. In the present example, the epitaxial growth of the GaN film 75 has been described, but even when the AlₓIn_{y}Ga_{z}N film (x+y+z=1 (0≦x, y, z, ≦1), AlₓGa₁₋ₓN film (0≦x≦1), InₓGa₁₋ₓN film (x≦1), InN film, InₓGa₁₋ₓAs film (x≦1), or InₓGa₁₋ₓP film (x≦1) is subjected to the epitaxial growth, the similar effect can be obtained. Furthermore, even when the impurities are doped, the similar effect can be obtained.

### Example 8

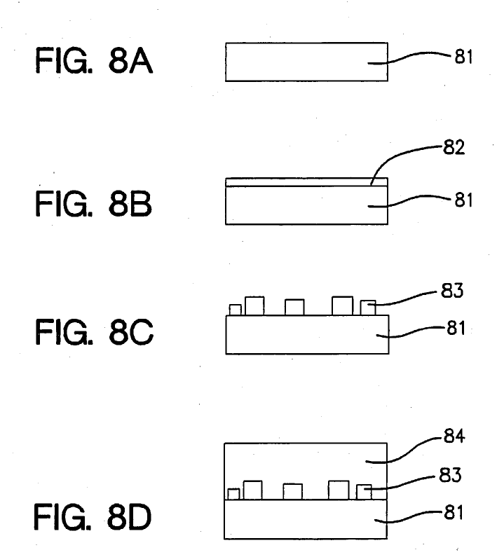

The present example will be described with reference to FIG. 8. In the present example a (0001) plane sapphire (Al₂O₃) substrate 81 is used as a substrate (FIG. 8(a)). A GaN layer 82 having a thickness of 50 nm is formed on the substrate 81 by the MOVPE method in which trimethylgallium (TMG) is used as a raw material of an element in the group III, an ammonia (NH₃) gas is used as a raw material of an element in the group V, and a hydrogen gas (H₂) and a nitrogen gas (N₂) are used as carrier gases (FIG. 8(b)). The thickness of the GaN layer 82 can appropriately be selected from a range of 20 to 300 nm.

A procedure of forming the GaN film 82 is as follows. First the sapphire substrate 81 with the cleaned surface is set in the growth region of the MOVPE apparatus. Subsequently, in the H₂ gas atmosphere, temperature is raised to 1050° C., and the heat treatment is performed on the surface of the substrate 81. Subsequently, the temperature is lowered to 500° C. After the temperature is stabilized, by supplying TMG and NH₃ by 10 μmol/min and 5000 cm³/min, respectively, and supplying the H₂ gas and the N₂ gas by 12000 cm³/min and 10000 cm³/min, respectively, the GaN layer 82 is formed. After the GaN film 82 is formed, only the N₂ gas is cooled to reach the normal temperature, and the substrate is removed from the MOVPE apparatus.

Subsequently, an insular GaN film 83, and a GaN layer 84 with a flat surface are formed in the same manner as in Example 7 by the hydride VPE method (HVPE) (FIGS. 8(c), (d)). A procedure of forming the insular GaN film 83 and GaN layer 84 is as follows. First, the substrate is set on the HVPE apparatus, and the H₂ gas is supplied while raising the temperature to 600° C. Furthermore, the NH₃ gas is supplied while raising the temperature to 1020° C. In the temperature raising process, most part of the GaN layer 82 is evaporated, and a particulate GaN film is formed. In order to preferably form the particulate GaN film, the thickness of the GaN film is preferably appropriately set in accordance with the temperature raising speed, growth temperature, and H₂ or NH₃ partial pressure.

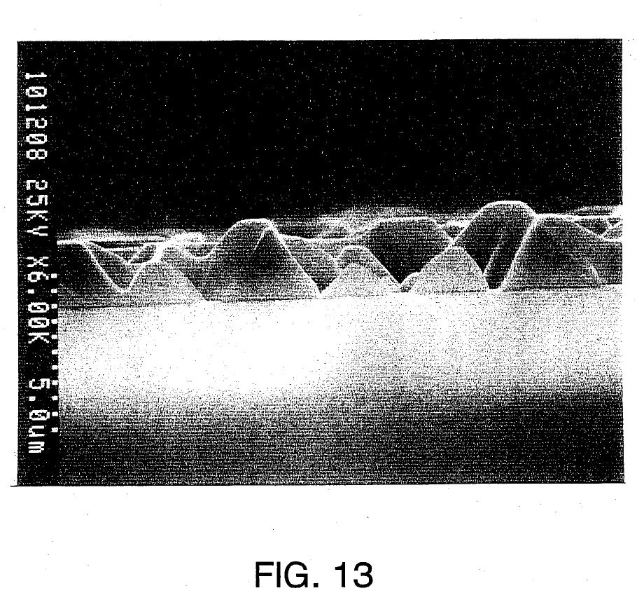

Subsequently, after the growth temperature is stabilized, GaCl is supplied to grow the GaN film 83. In the HVPE growth, the growth proceeds using substantially only the surface of the particulate GaN film 82 as a starting point, and the insular GaN film 83 is formed (FIG. 8(c)). A sectional SEM (scanning electron microscope) photograph in this state is shown in FIG. 13. In this case the amount of HCl supplied onto Ga is 5 cm³/min, and the supply amount of the NH₃ gas is 500 cm³/min.

By increasing the amount of HCl supplied onto Ga to 40 cm³/min and the flow rate of the NH₃ gas to 1200 cm³/min and continuing the epitaxial growth, the growth is performed on an insular GaN film 83 surface. As in Example 7, the GaN film 84 coalesces with the GaN film grown from the adjacent insular GaN layer 83. Furthermore, by continuing the growth, a flat surface can be formed. The GaN film 84 having a thickness of 300 μm can be formed by the growth for four hours. After the GaN film 84 is formed, the NH₃ gas is supplied, the cooling is performed to obtain about 600° C., and the supply of the NH₃ gas is stopped. Furthermore, the cooling is performed until the normal temperature is obtained, the H₂ gas is switched to the N₂ gas and the substrate is removed from the growth apparatus.

Neither crack nor fracture was observed in the GaN film 84 obtained as described above.

In the respective aforementioned examples, some cases where the nitride system of the element in the group III is applied to the present invention have mainly been described. However, the present invention skillfully utilizes the lateral growth, and does not limit the material to be subjected to the epitaxial growth. Therefore, the present invention can also be applied to the epitaxial growth of gallium arsenide (GaAs), silicon carbide (SiC) or the like on the silicon substrate. Furthermore, the heterogeneous base substrate is not limited to a single material, and a substrate formed of a plurality of layers of different materials can also be used.

### Example 9

In the present example, a case is shown in which after the epitaxial layer is formed by the method of the present invention, each semiconductor layer constituting a semiconductor laser is formed on the epitaxial layer.

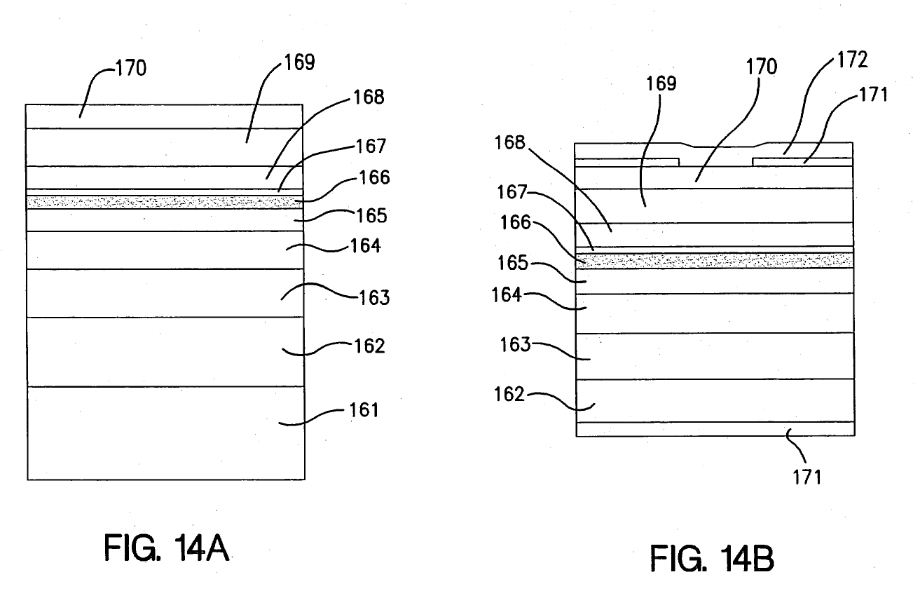

FIG. 14(a) is a schematic sectional view of a gallium nitride based laser formed by forming a GaN epitaxial layer (film thickness of 200 μm) 162 with silicon (Si) as an N-type impurity doped thereto on a sapphire (0001) plane substrate 161 in a method similar to that of Example 1, and using the metalorganic vapor phase epitaxy method (MOVPE) to grow semiconductor layers on the substrate.

In a GaN-based semiconductor laser structure, the substrate shown in (a) is set on the MOVPE apparatus, and the growth temperature is raised to 1050° C. in the hydrogen atmosphere. The NH₃ gas atmosphere is formed from a temperature of 650° C. By successively forming a 1 μm thick n-type GaN layer 163 to which Si is doped, a 0.4 μm thick n-type Al_{0.15}Ga_{0.85}N clad layer 164 to which Si is doped, a 0.1 μm thick n-type GaN photo-guide layer 165 to which Si is doped, a three-period multiple quantum well structure active layer 166 consisting of a 2.5 nm thick undoped In_{0.2}Ga_{0.8}N quantum well layer and a 5 nm thick undoped In_{0.05}Ga_{0.95}N barrier layer, a 20 nm thick p-type Al_{0.2}Ga_{0.8}N layer 167 to which magnesium (Mg) is doped, a 0.1 μm thick p-type GaN photo-guide layer 168 to which Mg is doped, a 0.4 μm thick p-type Al_{0.15}Ga_{0.85}N clad layer 169 to which Mg is doped, and a 0.5 μm thick p-type GaN contact layer 170 to which Mg is doped, a laser structure was prepared. After forming the p-type GaN contact layer 170, cooling is performed to obtain the normal temperature in the NH₃ gas atmosphere, and the structure is removed from the growth apparatus. The multiple quantum well structure active layer 166 consisting of the 2.5 nm thick undoped In_{0.2}Ga_{0.8}N quantum well layer and the 5 nm thick undoped In_{0.05}Ga_{0.95}N barrier layer was formed at a temperature of 780° C.

Next, a crystal with the laser structure formed thereon is set to an abrading machine, and the sapphire substrate 161 and GaN film 162 are ground by 50 μm. By forming a titanium (Ti)/aluminum (Al) n-type electrode 171 on an exposed GaN layer 165 surface, and forming an SiO₂ film 172 on the p-type GaN layer 170 to restrict an electric current, the nickel (Ni)/gold (Au) p-type electrode 172 was prepared (FIG. 14(b)).

Each semiconductor layer constituting the semiconductor laser as described above had a satisfactory crystal property and little dislocation. Moreover, yield was satisfactory, manufacture stability was superior, and room-temperature continuous operation was obtained with a threshold current density of 3 kA/cm², and a threshold voltage of 5 V.

In the present example, after the laser structure was formed on the GaN layer 162, a part of the sapphire substrate 161 and GaN film 162 was abraded, but the similar effect is obtained even when a part of the sapphire substrate 161 and GaN film 162 is abraded before preparing the laser structure.

This application is based on Japanese patent application NO.HEI11-301158, the content of which is incorporated hereinto by reference.

What is claimed:

1. A method of manufacturing a base substrate for crystal growth which is constituted of a base substrate and a plurality of insular crystals formed apart from one another on the base substrate and which is used as a base for growing an epitaxial crystal layer of a crystal system different from that of said base substrate, said method comprising:
a step of forming a buffer layer of the same crystal system as that of said epitaxial crystal layer on the surface of the base substrate directly or via another layer, and
a step of subjecting a part of said buffer layer to wet etching to leave an insular region, thereby forming said insular crystal including a single-crystal layer of the same crystal system as that of said epitaxial crystal layer.

2. A method of manufacturing a base substrate for crystal growth which is constituted of a base substrate and a plurality of insular crystals formed apart from one another on the base substrate and which is used as a base for growing an epitaxial crystal layer of a crystal system different from that of said base substrate, said method comprising:
a step of forming a first buffer layer at a first growth temperature on the surface of the base substrate directly or via another layer;
a step of forming a second buffer layer of the same crystal system as that of said epitaxial crystal layer at a second growth temperature higher than the first growth temperature; and
a step of subjecting a part of the first and second buffer layers to wet etching to leave an insular region, thereby forming said insular crystal including a single-crystal layer of the same crystal system as that of said epitaxial crystal layer.

3. The method of manufacturing the base substrate for crystal growth according to claim 1 wherein during the wet etching of said buffer layer, at least a part of the exposed surface of said base substrate is etched.

4. The method of manufacturing the base substrate for crystal growth according to claim 2 wherein during the wet etching of said buffer layer, at least a part of the exposed surface of said base substrate is etched.

5. A method of manufacturing a base substrate for crystal growth which is constituted of a base substrate and a plurality of insular crystals formed apart from one another on the base substrate and which is used as a base for growing an epitaxial crystal layer of a crystal system different from that of said base substrate, said method comprising:
a step of insularly depositing a crystal layer including a single-crystal layer of the same crystal system as that of said epitaxial crystal layer on the surface of the base substrate directly or via another layer to form said insular crystal.

6. The method of manufacturing the base substrate for crystal growth according to claim 5 wherein after said insular crystal is formed, at least a part of the exposed surface of said base substrate is etched.

7. The method of manufacturing the base substrate for crystal growth according to claim 1 wherein said insular crystal comprises a lower polycrystalline layer formed on said base substrate, and an upper single-crystal layer formed on the lower polycrystalline layer.

8. The method of manufacturing the base substrate for crystal growth according to claim 2 wherein said insular crystal comprises a lower polycrystalline layer formed on said base substrate, and an upper single-crystal layer formed on the lower polycrystalline layer.

9. The method of manufacturing the base substrate for crystal growth according to claim 5 wherein said insular crystal comprises a lower polycrystalline layer formed on said base substrate, and an upper single-crystal layer formed on the lower polycrystalline layer.

10. The method of manufacturing the base substrate for crystal growth according to claim 1 wherein a covering ratio of said plurality of insular crystals with respect to the surface of said base substrate is in a range of 0.1% to 60%.

11. The method of manufacturing the base substrate for crystal growth according to claim 2 wherein a covering ratio of said plurality of insular crystals with respect to the surface of said base substrate is in a range of 0.1% to 60%.

12. The method of manufacturing the base substrate for crystal growth according to claim 5 wherein a covering ratio of said plurality of insular crystals with respect to the surface of said base substrate is in a range of 0.1% to 60%.

13. The method of manufacturing the base substrate for crystal growth according to claim 1 wherein an average particle size of said plurality of insular crystals is in a range of 0.1 μm to 10 μm.

14. The method of manufacturing the base substrate for crystal growth according to claim 2 wherein an average particle size of said plurality of insular crystals is in a range of 0.1 μm to 10 μm.

15. The method of manufacturing the base substrate for crystal growth according to claim 5 wherein an average particle size of said plurality of insular crystals is in a range of 0.1 μm to 10 μm.

16. The method of manufacturing the base substrate for crystal growth according to claim 1 wherein an average interval between said adjacent insular crystals is in a range of 10 μm to 500 μm.

17. The method of manufacturing the base substrate for crystal growth according to claim 2 wherein an average interval between said adjacent insular crystals is in a range of 10 μm to 500 μm.

18. The method of manufacturing the base substrate for crystal growth according to claim 5 wherein an average interval between said adjacent insular crystals is in a range of 10 μm to 500 μm.

19. The method of manufacturing the base substrate for crystal growth according to claim 1 wherein a number density of said plurality of insular crystals is in a range of 10⁻⁵ crystals/μm² to 10⁻² crystals/μm².

20. The method of manufacturing the base substrate for crystal growth according to claim 2 wherein a number density of said plurality of insular crystals is in a range of 10⁻⁵ crystals/μm² to 10⁻² crystals/μm².

21. The method of manufacturing the base substrate for crystal growth according to claim 5 wherein a number density of said plurality of insular crystals is in a range of 10⁻⁵ crystals/μm² to 10⁻² crystals/μm².

22. The method of manufacturing the base substrate for crystal growth according to claim 1 wherein said epitaxial crystal layer is made of a nitride-based material of an element in the group III.

23. The method of manufacturing the base substrate for crystal growth according to claim 2 wherein said epitaxial crystal layer is made of a nitride-based material of an element in the group III.

24. The method of manufacturing the base substrate for crystal growth according to claim 5 wherein said epitaxial crystal layer is made of a nitride-based material of an element in the group III.

25. A base substrate for crystal growth manufactured by the method of manufacturing the base substrate for crystal growth according to claim 1.

26. A base substrate for crystal growth manufactured by the method of manufacturing the base substrate for crystal growth according to claim 2.

27. A base substrate for crystal growth manufactured by the method of manufacturing the base substrate for crystal growth according to claim 5.

28. A method of manufacturing a substrate which comprises a step of using the method of manufacturing the base substrate for crystal growth according to claim 1 to manufacture the base substrate for crystal growth, and a step of subsequently forming an epitaxial growth layer of the same crystal system as that of said insular crystal so as to embed said insular crystal.

29. A method of manufacturing a substrate which comprises a step of using the method of manufacturing the base substrate for crystal growth according to claim 2 to manufacture the base substrate for crystal growth, and a step of subsequently forming an epitaxial growth layer of the same crystal system as that of said insular crystal so as to embed said insular crystal.

30. A method of manufacturing a substrate which comprises a step of using the method of manufacturing the base substrate for crystal growth according to claim 5 to manufacture the base substrate for crystal growth, and a step of subsequently forming an epitaxial growth layer of the same crystal system as that of said insular crystal so as to embed said insular crystal.

31. A substrate manufactured by the method of manufacturing the substrate according to claim 28.

32. A substrate manufactured by the method of manufacturing the substrate according to claim 29.

33. A substrate manufactured by the method of manufacturing the substrate according to claim 30.
